(19) United States
(12) Patent Application Publication
(10) Pub. No.: US 2008/0215572 A1
(43) Pub. Date: Sep. 4, 2008

(54) METHOD AND APPARATUS FOR EVALUATING EQUIPMENT LEASES

(76) Inventors: John Boettigheimer, Plano, TX (US); Bernard Boettigheimer, Dallas, TX (US)

Correspondence Address: ANDERSON, LEVINE & LINTEL L.L.P., 14785 PRESTON ROAD, SUITE 650, DALLAS, TX, 75254, US

(21) Appl. No.: 12/027,397

(22) Filed: Feb. 7, 2008

Related U.S. Application Data
(60) Provisional application No. 60/888,782, filed on Feb. 8, 2007.

(51) Int. Cl. G06Q 10/00; G06F 7/06; G06F 17/30

(52) U.S. Cl. 707/5; 705/36 T; 707/E17.017

(57) ABSTRACT

A lease information processing system provides subscribers, such as funding sources and lease brokers, with information indicating whether a proposed lease may have an enhanced chance of premature termination, based on prior leases and concurrent leases by the vendor and lessee, along with reports of suspicious activity reported by other subscribers.

### CROSS-REFERENCE TO RELATED APPLICATIONS

This application claims the benefit of the filing date of copending provisional application U.S. Ser. No. 60/888782, filed Feb. 8, 2007, entitled “METHOD AND APPARATUS FOR EVALUATING EQUIPMENT LEASES”, which is incorporated by reference herein.

### STATEMENT OF FEDERALLY SPONSORED RESEARCH OR DEVELOPMENT

Not Applicable

### BACKGROUND OF THE INVENTION

1. Technical Field

This invention relates in general to financial transactions and, more particularly, to a method and apparatus for identifying potentially fraudulent or otherwise undesirable leasing situations.

2. Description of the Related Art

FIG. 1a illustrates a basic diagram illustrating a typical commercial lease of equipment. A vendor provides equipment and a (potential) lessee wishes to lease the equipment provided by the vendor. A third party lender (funding source) enters into a contract with the lessee. Once executed, the lessee receives the equipment from the Vendor. The vendor is paid for the equipment by the funding source and the funding source receives title to the equipment. The Lessee makes payments to the funding source pursuant to the contract.

The funding source typically assumes some risk that the Lessee might not be successful and might fail to make payments. The funding source generally checks out referrals and third party sources, such as D & B (DUN & BRADSTREET) reports, to ensure that the lessee is financially able to make the lease payments prior to approving the transaction. FIG. 1b illustrates the effect of an unsatisfactory termination of a lease. If the Lessee makes an early unsatisfactory termination of the contract resulting in repossession, the equipment is returned to the funding source. The funding source generally has no choice but to sell the equipment, possibly at a loss.

Some early terminations cannot be anticipated. Other terminations are due to factors involving the vendor, or particular sales people working for the vendor, ranging from aggressive sales procedures to outright fraud. However, the funding source will seldom have enough information on a vendor to fairly evaluate poor leasing situations before credit approval.

Therefore, a need has arisen for a method and apparatus for identifying situations which have an enhanced risk of early termination for reasons other than poor credit.

### BRIEF SUMMARY OF THE INVENTION

In the present invention, equipment leases are evaluated using a processing device. An input interface receives inquiries from a subscriber concerning prospective leases of equipment from vendors to prospective lessees and receives information regarding terminated leases. A database stores the inquiries and information regarding terminated leases. An output interface provides information about a specified prospective lessee and a specified vendor including prior inquiries for equipment leases involving the specified prospective lessee, prior inquiries for equipment leases involving the specified vendor, prior equipment leases terminated by the specified prospective lessee and terminated equipment leases of equipment supplied by the specified vendor.

The present invention provides significant advantages over the prior art. Numerous bad leasing situations can be identified from the history of inquiries regarding a vendor and prospective lessee and a history of terminated leases involving equipment from a particular vendor and terminated leases by a prospective lessee. Hundreds of millions of dollars can be saved each year by identifying bad leasing situations.

### BRIEF DESCRIPTION OF THE SEVERAL VIEWS OF THE DRAWINGS

For a more complete understanding of the present invention, and the advantages thereof, reference is now made to the following descriptions taken in conjunction with the accompanying drawings, in which:

FIGS. 1a and 1b illustrates a basic diagram illustrating a commercial lease situation;

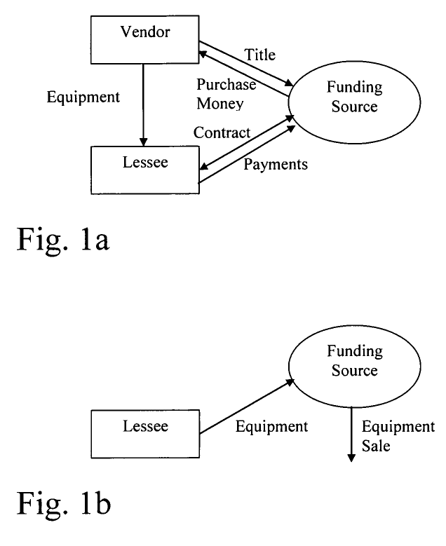

FIG. 2 illustrates an information system for identifying poor leasing situations to aid in evaluation of a proposed lease by funding sources;

FIG. 3 illustrates a basic functional diagram of the lease information processing system of FIG. 2;

FIG. 4 illustrates a basic inquiry and search screen;

FIG. 5 illustrates a results screen for the search of FIG. 4;

FIG. 6 illustrates a lessee detail screen;

FIGS. 7a and 7b illustrate a vendor detail screens;

FIG. 8 illustrates a unusual vendor/lessee activity screen;

FIG. 9 illustrates a terminated lease screen;

### DETAILED DESCRIPTION OF THE INVENTION

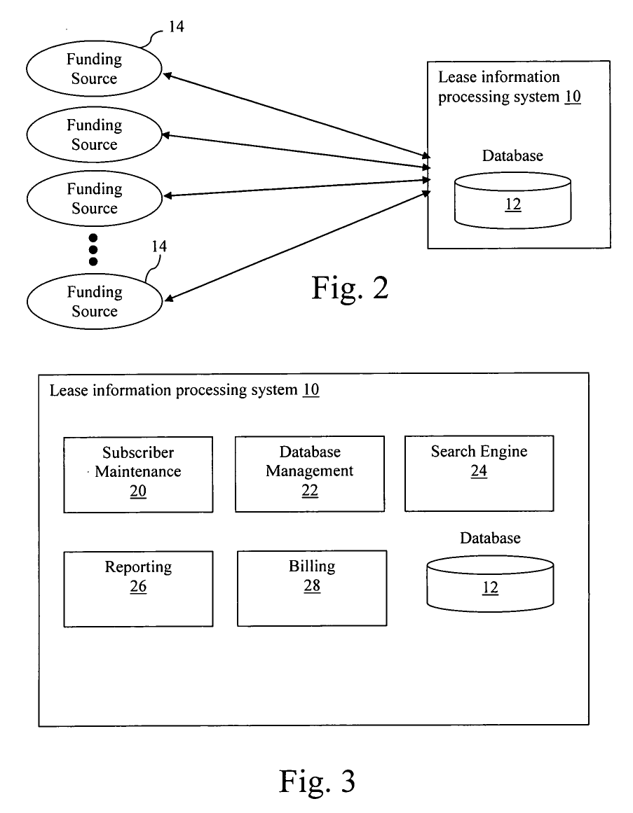

The present invention is best understood in relation to FIGS. 2-9 of the drawings, like numerals being used for like elements of the various drawings.

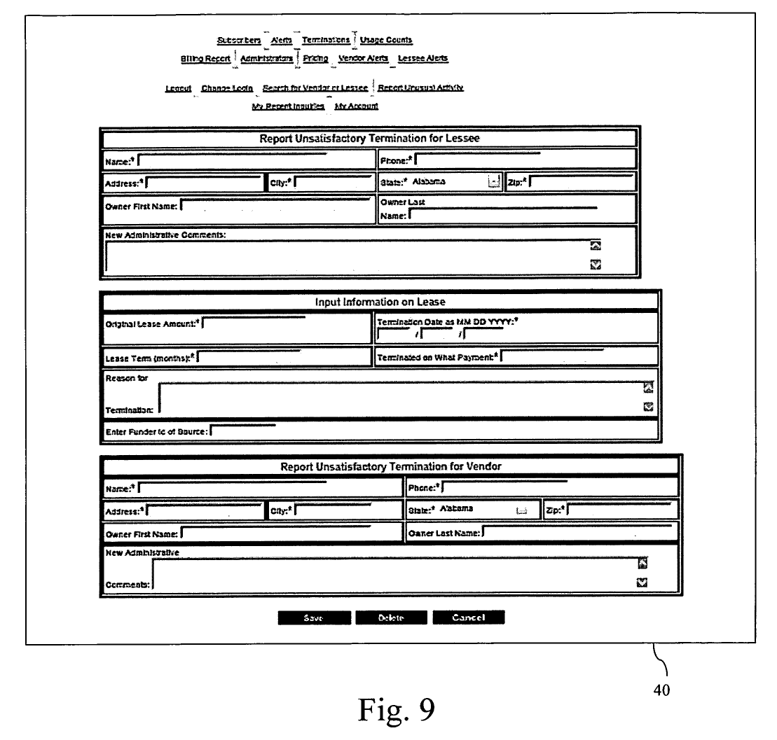

FIG. 2 illustrates an information system for identifying poor leasing situations for funding sources. A lease information processing system 10 including database 12 are accessible to a number of subscribing funding sources. Funding sources 14 provide information on their terminated leases (including archival terminated lease information, if available); the information for each terminated lease includes the date and term of a lease, amount of lease, lease termination date, and so on (see FIG. 9). This information is stored in the database 12, along with information about vendors and lessees that is derived from other sources and derived information, such as a score/rating associated with a vendor.

When a leasing opportunity arises, the funding source inputs the details of the lease. Typically, the lease information processing system 10 is a web site accessible over the Internet or other publicly accessible network. The lease information processing system 10 interfaces between subscriber and the data in database 12 to provide details on the vendor and lessee involved in a proposed lease. From this information, the funding source can make an informed decision on whether or not to pursue the lease. The processing capabilities needed to provide the information as shown hereinbelow are common to existing web servers and personal computers.

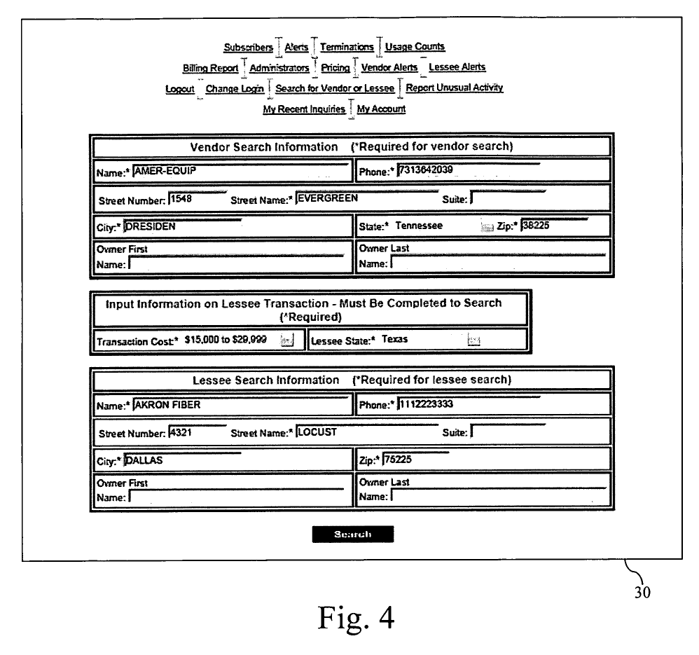

FIG. 3 illustrates a basic functional diagram of the lease information processing system 10. The lease information processing system 10 provides modules for subscriber maintenance 20, database management 22, search engine 24, reporting 26 and billing 28. Other functions could be provided as well.

Subscriber maintenance 20 allows subscribers to sign up to access information from the lease information processing system. In the preferred embodiment, only funding sources and lease brokers (who arrange leases between funding sources and lessees) are allowed access to the lease information processing system; brokers are restricted in their use to prevent the system from being used for marketing purposes, rather than for obtaining information on an actual proposed lease. A subscriber entry screen collects information about a subscriber, including the subscriber's name, address, phone, and e-mail. This information may also be supplied by phone or fax. The information is sent to an administrator for approval and set-up of the subscriber. After approval, a subscriber can access the system by entering a login name (or email address) and password.

Database management 22 controls the flow of information to and from the database 12. Information is retrieved from the database 12 responsive to subscriber queries. Information is sent to the database 12 responsive to subscriber inputs relative to prematurely (or otherwise unsatisfactory) terminated leases and to suspicious activity alerts. All information from subscribers is preferably checked by an administrator prior to be entered in the database 12.

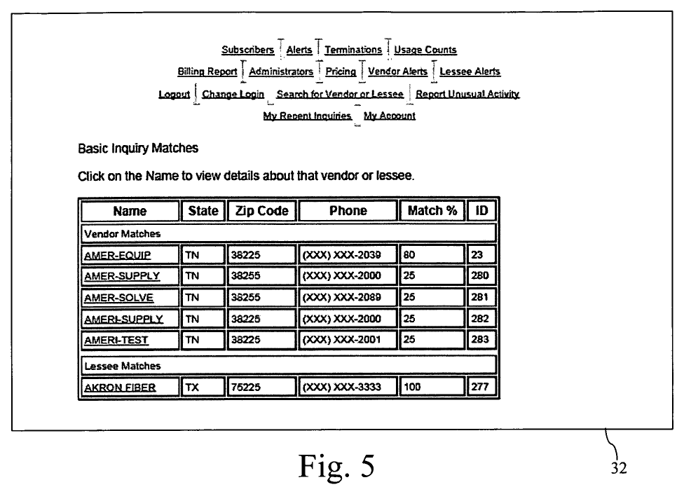

Search engine 24 retrieves information from the database 12 responsive to a subscriber inquiry. Based on input to a basic inquiry and search screen (see FIG. 4), relevant information is retrieved from the database 12 and presented to the subscriber in a desired form. As shown below, data retrieved from the database 12 may be linked to other relevant information.

Reporting 26 prepares reports of subscriber searches.

Billing 28 generates bills responsive to subscriber activity.

FIG. 4 illustrates a basic inquiry and search screen 30. The subscriber inputs data associated with a proposed lease, i.e., a lease which the subscriber is considering funding (or brokering a deal for funding), including data identifying the vendor (name, address, phone, and owner name), the lessee (name, address, phone and owner name), and the terms of the contract (amount, state of lease).

From the information entered by the subscriber, the search engine 24 determines whether there is information on the vendor and/or lessee in the database 12. In the preferred embodiment, the results of the search include information on parties that may loosely match the information in the inquiry 30, since it is possible that one or both of the parties may use false names or addresses to hide an undesirable past. Search results may be ranked in order of closeness to the information provided in the inquiry.

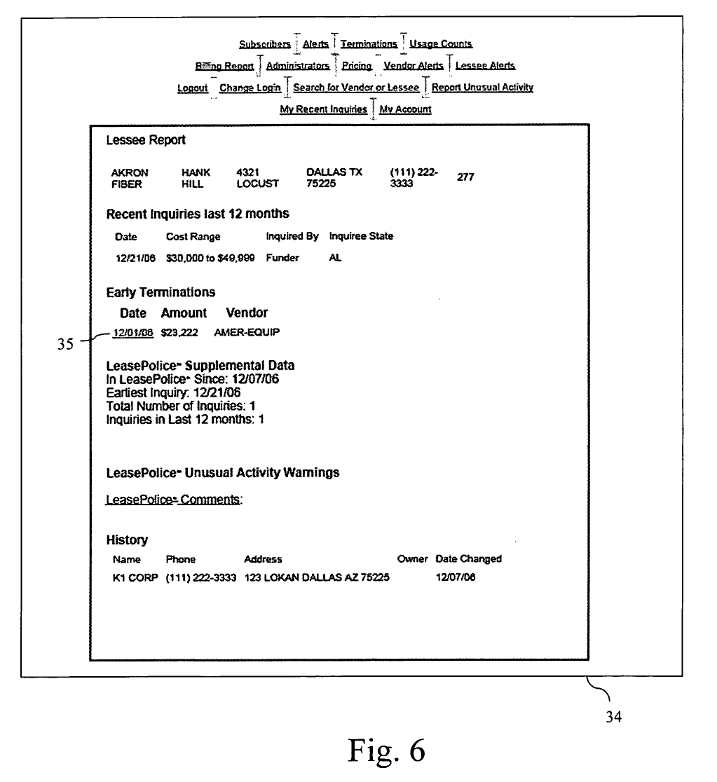

FIG. 5 illustrates a results screen 32 for the search of FIG. 4. In this example, the vendor search has identified five companies (all fictitious in the example) with similar names in the same zip code (one being identical to the search criteria). Since these companies may be related and, therefore, have relevant information, all five companies may be viewed. For the lessee, in the illustrated example, only one company is identified.

By clicking on a name of a vendor or lessee shown in the results screen 32, the details for that entity can be viewed.

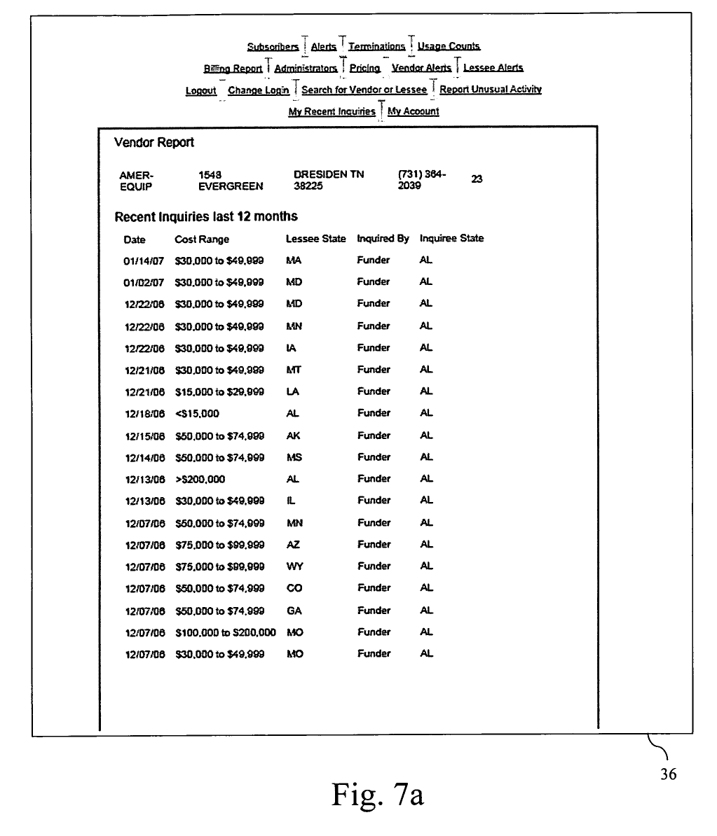

In FIG. 6, the detail screen 34 for the prospective lessee is shown. The detail screen 34 lists the inquiries (by any subscriber) for this lessee in the last 12 months and any early terminations associated with the lessee that have been reported by the subscribers (or independently found). In this case, there is another instance of a lease between the specified vendor and lessee which was terminated. The detail screen 34 for the lessee shows all terminated leases associated with the lessee, not just those leases with the particular vendor in the search. Clicking on the hyperlink 35 associated with the early termination will provide details of the early termination. Additionally, the lessee detail screen provides data on how long lessee information has been in the database, the date of the earliest inquiry, the total number of inquiries and the number of inquiries in the last twelve months. A list of unusual activity warnings (none for this lessee) are listed, which can be investigated further. A history of the lessee, including related companies and prior addresses, is also provided.

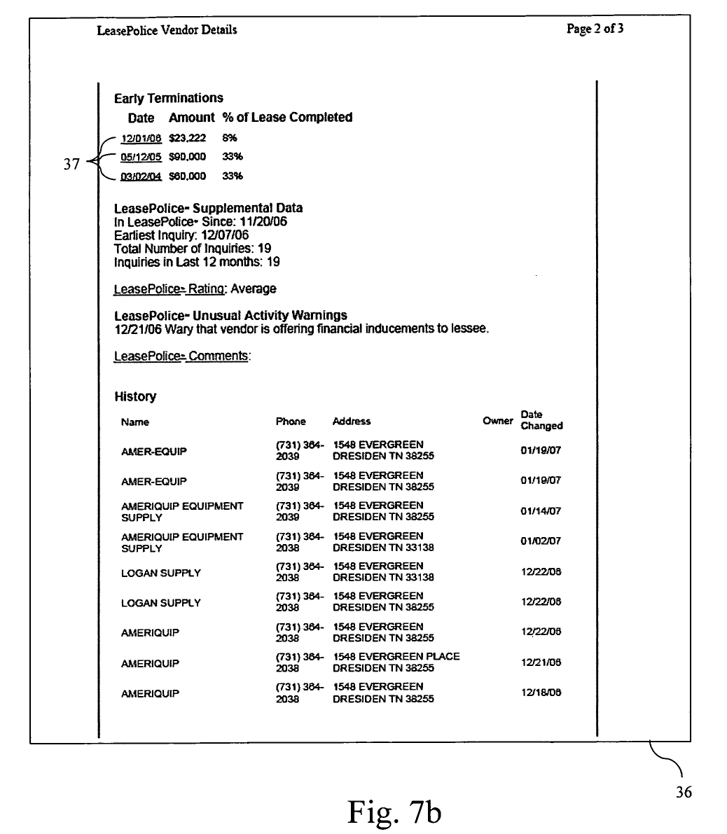

In FIGS. 7a and 7b, the detail screen 36 for the identified vendor is shown. In FIG. 7a, the detail screen 36 lists other inquiries for this vendor in the last 12 months and, in FIG. 7b, the continuation of the detail screen 36 lists any early terminations associated with the vendor, specifying the percentage of the lease that was completed prior to termination. In this case, in addition to the terminated lease between the specified vendor and lessee, two other leases were terminated. Clicking on the hyperlink 37 associated with the early termination will provide details of the early termination. Additionally, the vendor detail screen 36 provides data on how long vendor information has been in the database, the date of the earliest inquiry, the total number of inquiries and the number of inquiries in the last twelve months. A rating (in this case “average”) is determined, described in greater detail below. A list of unusual activity warnings (one for this vendor, indicating that the vendor may be providing inducements) are listed, which can be investigated further. A history of the vendor, including related companies and prior addresses, is also provided.

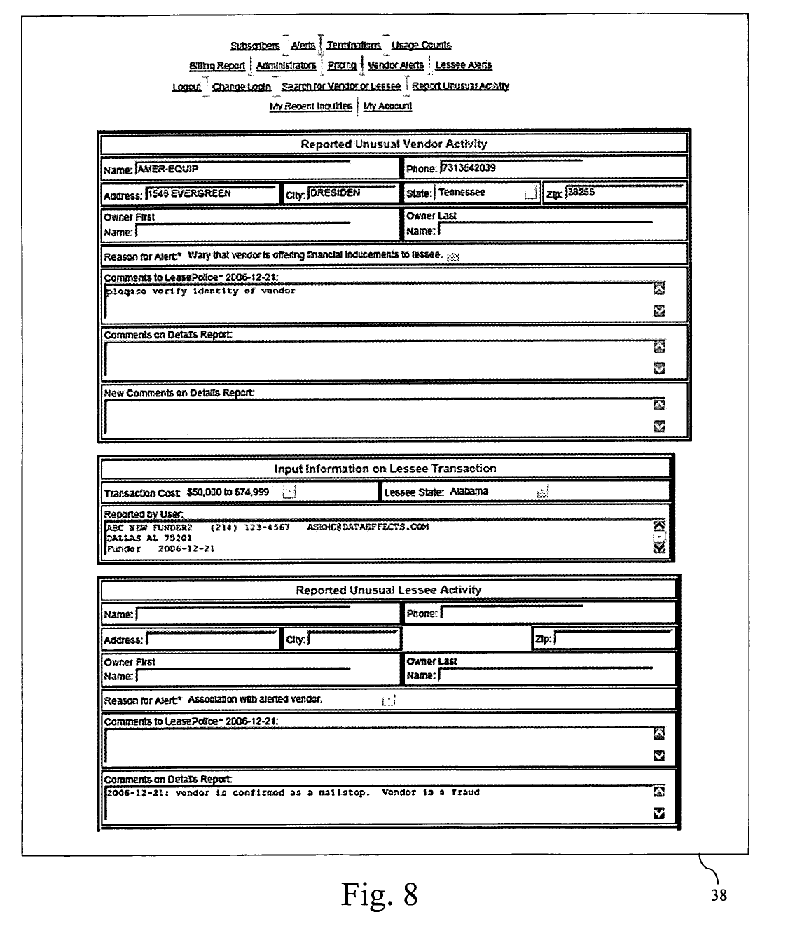

FIG. 8 is a reported unusual vendor/lessee activity screen 38. This screen is provided for a subscriber to report unusual activity by a vendor or lessee. The subscriber identifies the vendor and/or lessee participating in the unusual activity and adds comments, which will be posted to the detail screens 34 and/or 36 for the lessee and vendor, after being investigated by an administrator for the lease information processing system 10. To investigate an unusual activity, the administrator may use a number of resources including but not limited to directory assistance listings, American Business Lists/Prophone reports, Accurint reports (Lexus Nexis), criminal filings reports (publicdata.com), secretary of state information (incorporation info), UCC filings, D&B reports, credit bureau reports (Experian, Trans Union, Equifax), narrow based internet searches (Google, Yahoo and others), tax id number verification through government websites, real estate records (county databases), sales tax permits (knowx.com and various state websites), satellite overhead pictures (MSN local live and Google), who is database (internet search), and website rankings (alexa.com). From this data, the administrator may be able to determine when company was formed, ownership information, when the company started selling products, when their website became live and how active it is, criminal records of owners, what types of cars the owners drive, their known associates, prior addresses of business, known neighbors of business, how long firm has been listed in directory assistance, pay history to their suppliers, who their lenders are, what property they own, who their mortgage lenders are, personal pay history of the owners, and what type of building they operate in.

FIG. 9 illustrates a terminated lease screen 40 which is filled out by subscribers whenever they are a party to a prematurely terminated lease. The subscriber identifies the vendor and/or lessee participating in the unusual activity and enters the term of the prematurely terminated lease, including lease amount, term, termination date, payment upon which the lease was terminated, reason for termination, and vendor information.

As described above, the subscribers of the lease information processing system 10 provide information to the system in at least three different ways: (1) inquiries of vendors and lessees, (2) information on prematurely terminated leases and (3) alerts of unusual activities. From this information, a score for a vendor can be generated using a simple formula, which compares the number of inquiries over a certain time period (indicative of the volume of equipment that the vendor is leasing) with the number of early terminations and activity warnings. One example of such a formula would be:

$$\frac{inquiries of vendor in last x mos * m}{\# of months in system} + \frac{\# of terminations in 70 \% of term * n}{\# of months in system}$$

where n and m are weighting factors and x defines an observation window. Typical numbers would be m=10, n=100 and x=6. The left hand side of the equation helps detect fraud situations, where a vendor comes onto the system and suddenly generates a large number of inquiries. In most cases, this portion of the equation will be a relatively low score, and will decrease as the vendor remains in the system. Fraudulent vendors, of course, will be detected and eliminated from the marketplace. The right side of the equation provides insight into vendors who are over-aggressively marketing their products. The numerator tracks the number of terminations prior to completion of 70% of the lease term. This factor identifies poor leasing situations, even where the vendor and lessee both appear to be legitimate and qualified.

Using the factors m=10, n=100 and x=6, a couple of typical examples are provided herein. For a vendor that has had 10 inquiries within the last six month time period, and has been in the system for 12 months with four early terminations, the score would be 10*10/12+4*100/12=8+33=41. For a vendor that has 20 inquiries in the last six months and has been in the system for six months with three early terminations, the score would be 20*10/6+3*100/6=33+50=83.

For a vendor that has an alert, the score is set at 100 regardless of the score from the formula.

Using the formula shown, a high score would represent a high risk factor. If desired, the numeric score could be translated to a category, such as “excellent”, “good”, “average”, “poor”, based on numeric scores of other vendors/lessees in the database. For example, the numeric rankings could be translated to category rankings, such as poor=>66, average=33 to 65 and good=1 to 33, with a score of 0=no ranking.

The vendor ranking, however, should not be the sole reason for funding or denying a potential lease. Rather, the totality of the information should be used to determine whether the vendor and lessee are participating in an arms length transaction, or whether the potential lease may be driven by irregularities outside of the lease. For example, a number of irregularities may be identified by the information provided by the information processing system 10, including:
Collusion—where the vendor overprices equipment with a kick-back to the lessee, perhaps to be used as working capital or to be used to offset a delinquent open account on the part of the lessee.
Sale-leaseback—where the Vendor presents itself as owner of the equipment to be leased, even though the equipment is actually owned by the lessee from a previous purchase (or possibly is being leased from a third party funding source, who may hold a purchase money security interest in the equipment).
Misrepresentation of future services—where the vendor promises to provide future services without which the equipment is useless or severely devalued.
Misrepresentation of intended use—where the vendor misrepresents the intended use of the collateral; for example, the vendor may specify that the equipment is meant to perform a specific task only to have it fail to perform, rendering it useless to the lessee.
Dividing a large transaction—where the vendor divides a large transaction into numerous smaller leasing deals to propose to multiple funding sources to bypass safeguards. For example, a number of smaller deals may be used to avoid financial statements from the lessee, where the large transaction, if sent to a single funding source, would likely be declined because of financial weakness on the part of the lessee.
Marketing misrepresentations—where the vendor promises results that cannot reasonably be met through normal use of the equipment, such as reduced expenses or increased sales.
Vendor misleadingly aids in credit application preparation—where the vendor advises potential lessees to provide misleading or false information on the credit application, such as listing a spouse as owner of a company, where the true owner would be found in bankruptcy records, using false references and so on.
Vendor selling used equipment—where the supposedly new equipment passed under the lease is actually used equipment.
Buyback promises—where the vendor falsely promises to take back the equipment if certain lessee expectations aren't met.
False invoicing—where the vendor knowingly supplies an invoice to the funding source which is known to be false, such as having an incorrect ship-to address, name of lessee, amount of sale, date of sale (which may be important in view of the 30 day rule to preserve a purchase money security interest in the equipment).

Most problems with dealing with fraud or deception or over-marketing by a vendor will become apparent by the number of early terminations associated with a vendor. Even a few early terminations should be an indication that a closer look is required. For example, further insight into a potential problem lease would include one or more of the following: a UCC search, site inspection, verbal discussions with the lessee, Dun & Bradstreet reports on one or both of the parties, investigation on other search engines. Splitting a transaction into smaller transactions will become apparent by multiple inquiries on the lessee over a small period of time. Multiple inquiries on a lessee may also expose early turn downs of the lease application, especially where later applications show different information—ownership, time in business, references, and so on.

Accordingly, the present invention provides important information that can be used to evaluating a lease opportunity for a funding source, providing information that was heretofore unavailable. This information can lead to identification of situations likely to lead to early terminations by the lessee. Further, the informed decision whether to accept a lease may protect the funding source in the event that the lessee fails and blames the funding source as colluding with the vendor to sell equipment that did not meet the expectations promised by the vendor. The search engine 24 could highlight situations which are indicative of a poor leasing situation, by using colors, symbols or written warnings.

Although the Detailed Description of the invention has been directed to certain exemplary embodiments, various modifications of these embodiments, as well as alternative embodiments, will be suggested to those skilled in the art. The invention encompasses any modifications or alternative embodiments that fall within the scope of the Claims.

1. A system for evaluating equipment leases using a processing device, comprising:
an input interface for receiving inquiries from a plurality of subscribers concerning prospective leases of equipment from vendors to a prospective lessees and for receiving information regarding terminated leases;
a database for storing the inquiries and information regarding terminated leases; and
an output interface for providing information about a specified prospective lessee and a specified vendor including prior inquiries for equipment leases involving the specified prospective lessee, prior inquiries for equipment leases involving equipment provided by the specified vendor, prior equipment leases terminated by the specified prospective lessee and terminated equipment leases of equipment provided by the specified vendor.

2. The system of claim 1 wherein the input interface further receives warnings from subscribers about unusual activity by vendors or prospective lessees.

3. The system claim 1 and further comprising a search engine for filtering information in the database responsive to an inquiry.

4. The system of claim 3 wherein the search engine determines other records of lessees that may be affiliated with the specified lessee.

5. The system of claim 3 wherein the output interface provides ratings for vendors based on information in the database.

6. The system of claim 5 wherein the ratings for each vendor are based at least in part on the number of inquiries for the vendor, the number of terminated leases involving equipment supplied by the vendor, and warnings about the vendor.

7. The system of claim 1 wherein the output interface further provides information regarding the percentage of completion for each terminated lease of equipment by the specified vendor.

8. A method of evaluating equipment leases using a processing device, comprising:
providing an input interface for receiving inquiries from a plurality of subscribers concerning prospective leases of equipment from vendors to a prospective lessees and for receiving information regarding terminated leases;
storing the inquiries and information regarding terminated leases in a database; and
providing an output interface for providing information about a specified prospective lessee and a specified vendor including prior inquiries for equipment leases involving the specified prospective lessee, prior inquiries for equipment leases involving equipment provided by the specified vendor, prior equipment leases terminated by the specified prospective lessee and terminated equipment leases of equipment provided by the specified vendor.

9. The method of claim 8 wherein the step of providing an input interface includes the step of receiving warnings from subscribers about unusual activity by vendors or prospective lessees.

10. The method claim 8 and further comprising the step of filtering information in the database responsive to an inquiry using a search engine.

11. The method of claim 10 wherein the filtering step includes the step of determining other records of lessees that may be affiliated with the specified lessee.

12. The method of claim 10 wherein the step of providing an output interface includes the step of providing ratings for vendors based on information in the database.

13. The method of claim 12 wherein the step of providing ratings for each vendor comprises the step of calculating ratings based at least in part on the number of inquiries for the vendor, the number of terminated leases involving equipment supplied by the vendor, and warnings about the vendor.

14. The method of claim 8 wherein the step of providing an output engine further includes the step of providing information regarding the percentage of completion for each terminated lease of equipment by the specified vendor.
